(19) United States
(12) Patent Application Publication
(10) Pub. No.: US 2013/0021376 A1
(43) Pub. Date: Jan. 24, 2013

(54) Changing Orientation of Displayed Data Responsive to Window Resizing

(71) Applicants: Ansuman Tapan Satpathy, Sunnyvale, CA (US); Binu Abraham, Johnston, IA (US); Seang Y. Chau, San Jose, CA (US); Su-Yin Gan, Mountain View, CA (US); Tae Jin Kim, San Diego, CA (US); Haitang Wang, San Jose, CA (US)

(72) Inventors: Ansuman Tapan Satpathy, Sunnyvale, CA (US); Binu Abraham, Johnston, IA (US); Seang Y. Chau, San Jose, CA (US); Su-Yin Gan, Mountain View, CA (US); Tae Jin Kim, San Diego, CA (US); Haitang Wang, San Jose, CA (US)

(73) Assignee: MOTOROLA MOBILITY, INC., Libertyville, IL (US)

(21) Appl. No.: 13/187,323

(22) Filed: Jul. 20, 2011

(51) Int. Cl. G09G 5/00

(52) U.S. Cl. 345/649

(57) ABSTRACT

A method and apparatus for reorienting displayed data responsive to resizing a window in which the data is displayed is disclosed. Data is displayed in a window in a first orientation. Responsive to receiving an input modifying the size of the window, it is determined whether to reorient the data displayed in the window based on the modified size of the window. For example, if the modified size of the window exceeds a threshold, the data is reoriented. Responsive to determining to reorient the data, the window is resized to the modified size and the data is displayed in a second orientation. In one embodiment the first orientation is orthogonal to the second orientation.

### FIELD OF THE DISCLOSURE

The present disclosure relates generally to mobile device systems, and more particularly to displaying data using a mobile device system including multiple environments.

### BACKGROUND

Computing devices use operating systems to manage physical resources, applications and perform additional functions. Typically, operating systems are designed and optimized based on specific applications and user desired performance. Additionally, operating systems may also be customized to improve the performance of a specific hardware configuration or configurations. While different operating systems may operate better with different types of computing devices, it is desirable to have applications used by one operating system accessible to a different operating system.

Operating systems, such as LINUX® or WINDOWS®, configured for use by general-purpose computing devices (also referred to as a “general-purpose operating systems”) have an extensive set of features such as file systems, device drivers, applications, libraries, etc. General-purpose operating systems allow concurrent execution of multiple programs, and attempt to optimize the response time (also referred to as latency time) and/or processor usage, or load, associated with the concurrently executing programs. However, operating systems configured for use by general-purpose computing devices are typically unsuitable for embedded real-time applications, such as use in mobile computing devices such as smartphones or tablet computers. In certain circumstances, however, it is desirable for a mobile computing device to combine the performance associated with a mobile computing device-specific embedded operating system and one or more features of a general-purpose operating system.

For example, LINUX® is a commonly-used general purpose operating system with many features that would also benefit mobile computing devices. However, LINUX® was not designed to be used as an embedded, or real-time, operating system for use by mobile computing devices. Currently, many devices, such as set top boxes, mobile phones and car navigation systems require features of a general purpose operating system, such as LINUX®, as well as features of an embedded, or real-time operating system, including real time performance.

Given that general-purpose operating systems offer certain benefits while embedded operating system offer other benefits, particularly when used by certain types of devices, such as mobile computing devices, implementing multiple operating systems on a single device allows a device to take advantage of benefits from different types of operating systems. Conventional methods for running multiple operating systems on a single device rely on virtualization techniques. However, because virtualization emulates a complete computing device, the emulated computing device implements and operates one or more software stacks. Additionally, emulation of a computing device introduces significant overhead, making conventional virtualization techniques impractical for certain types of devices, such as mobile devices.

Additionally, many embedded operating systems support presenting data in different orientations, allowing data to be differently viewed based on the orientation of the device executing the embedded operating system. For example, a mobile computing device may display data in a portrait orientation when the mobile computing device is in a first orientation and may display data in a landscape orientation when the mobile computing device is in a second orientation. This re-orientation of data can be achieved by merely re-positioning the mobile computing device. However, if data from an embedded operating system is accessed through a general-purpose operating system, it is more difficult to re-orient the data viewed, which may impair a user's ability to view or manipulate data.

### BRIEF DESCRIPTION OF THE FIGURES

The accompanying Figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a mobile computing system including multiple environments in accordance with some embodiments.

FIG. 2 is a block diagram of additional components of a mobile computing system including multiple environments in accordance with some embodiments.

FIG. 3 is a block diagram of an example run-time coexistence schema in accordance with some embodiments.

FIG. 4 is a flow chart of a method for booting a mobile computing system including multiple environments in accordance with some embodiments.

FIG. 5 is a flow chart of a method for reorienting data responsive to resizing a window including data in accordance with some embodiments.

FIG. 6 is an event diagram of a method for reorienting data responsive to resizing a window including data in accordance with some embodiments.

FIG. 7 is an event diagram of an alternative method for reorienting data responsive to resizing a window including data in accordance with some embodiments.

FIG. 8 is an event diagram of another method for reorienting data responsive to resizing a window including data in accordance with some embodiments.

FIGS. 9A-9C illustrate an example of reorienting data responsive to resizing a window in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method for reorienting data displayed in a window responsive to resizing the window is disclosed herein. Data having a first orientation is displayed in a window having a size and an input modifying the size of the window is received. The modified size of the window is used to determine whether to reorient the data displayed in the window. For example, it is determined whether a border of the window is moved to a location exceeding a threshold location. As another example, it is determined whether an aspect ratio associated with displaying data in the first orientation in the window having the modified size differs from a predetermined aspect ratio. Responsive to determining to reorient the data displayed in the window, the window is resized to the modified size and the data is displayed in the second orientation using the window having the modified size.

In the following description, for purposes of explanation, numerous specific details are set forth to provide a thorough understanding of the invention. However, it will be apparent to one skilled in the art that the invention can be practiced without these specific details. In other instances, structures and devices are shown in block diagram form in order to avoid obscuring the invention.

### System Overview

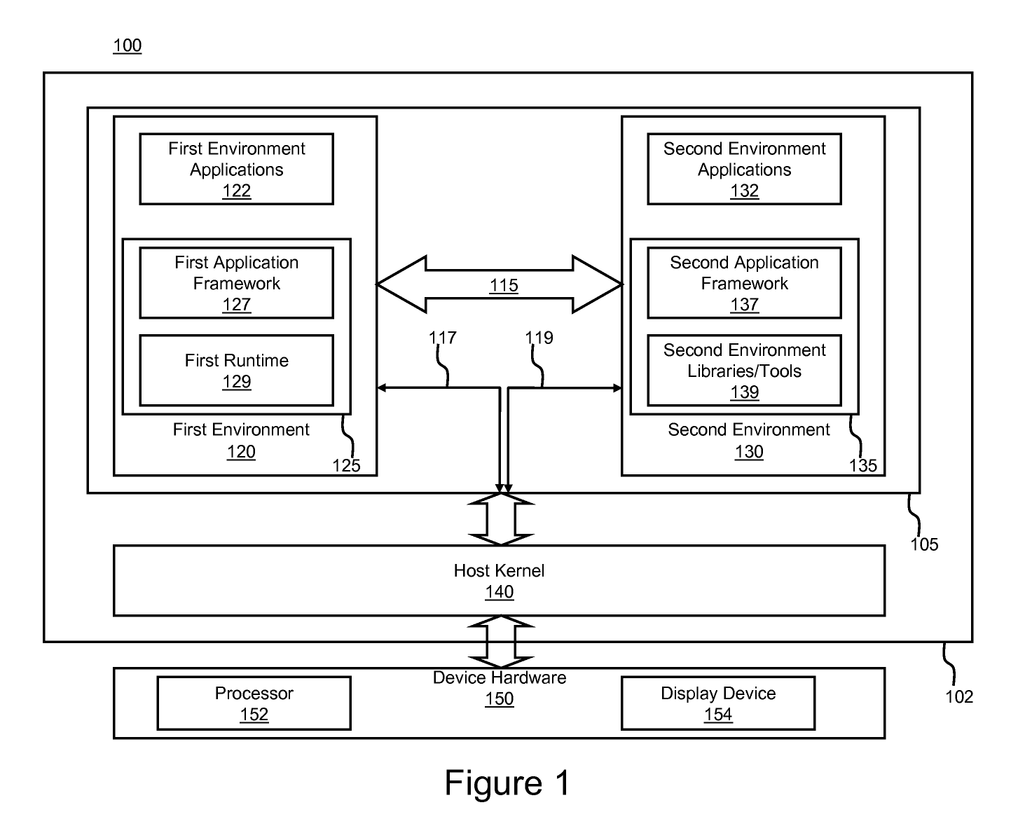

FIG. 1 is a block diagram of a mobile computing system 100 including multiple environments in accordance with some embodiments. The mobile computing system 110 shown by FIG. 1 includes a host operating system 102 communicating with device hardware 150 using a host kernel 140. The host operating system 102 also includes a host user component 105 that communicates with the host kernel 140. In one embodiment, the host operating system 102 is a LINUX®, or similar, operating system, such as a GNU/Linux operating system. In such an embodiment, the host kernel 140 is a LINUX® kernel and the host user component 105 is a LINUX® user component. However, in other embodiments, a different type of kernel may be used as the host kernel 140.

The host user component 105 includes a first environment 120 and a second environment 130. Both the first environment 120 and the second environment 130 communicate with the host kernel 140. Hence, a single host kernel 140 is used by the first environment 120 and the second environment 130. In the example shown by FIG. 1, the first environment 120 communicates with the host kernel 140 via communication link 117 and the second environment 130 communicates with the host kernel 140 via communication link 119. In one embodiment, the host kernel 140 is a LINUX® kernel, the first environment 120 is an embedded environment, such as an environment used by mobile devices, while the second environment 130 is a general purpose operating system. For example, the host kernel 140 is a LINUX® kernel, the first environment 120 is an ANDROID™ environment and the second environment 130 is a GNU/Linux environment. However, in other embodiments, the first environment 120 and the second environment 130 may be any suitable operating environment. Either real-time or non-real time environments or operating systems may be employed by the first environment 120 or the second environment 130. While FIG. 1 shows an embodiment including a first environment 120 and a second environment 130, in other embodiments, a greater number of operating environments may be included in the host user component 105; thus, more than two environments may operate and coexist independently of each other using a single host kernel 140, as further described below. Additionally, the first environment 120 and the second environment 130 communicate with each other via communication link 115.

In one embodiment, the first environment 120 and the second environment 130 operate and coexist independently of each other. In certain embodiments, the first environment 120 and the second environment 130 are interdependent in at least some aspects of operation. For example, the first environment 120 and the second environment 130 interact with the host kernel 140 and compete for resources of the host kernel 140. As another example, the first environment 120 and the second environment 130 communicate data with each other using communication link 115, so the first environment 120 and the second environment 130 may operate in conjunction with one another for at least some operations or actions. The host kernel 140 allocates resources of the mobile computing system 100 by connecting and managing interaction between the device hardware 150 and the first middleware 125 and/or the second middleware 135.

However, for purposes of explanation, the first environment 120 and the second environment 130 are considered “independent” in that each of the environments 120, 130 is capable of operating by itself if the other environment is not present or is not operational. For example, the first environment 120 may operate if the second environment 130 is not present. As another example, one of the environments 120, 130 is operationally independent before the other environment 130, 120 is implemented using the host kernel 140. In some embodiments, the first environment 120 and the second environment 130 are “independent” in that each of the environments 120, 130 is a different type of environment serving different operations and functions performed via the host kernel 140, the device hardware 150 and other components such as users or additional devices. For example, the first environment 120 implements functions or operations commonly associated with an embedded operating system, such as an operating system used by a mobile computing device, while the second environment 130 implements functions or operations commonly associated with a general purpose operating system, such as an operating system used by a desktop or laptop computer.

FIG. 1 further illustrates example components used by the first environment 120 and example components used by the second environment 130. In one embodiment, the first environment 120 includes first environment applications 122 and first middleware 125, which communicates with the first environment applications 122. For example, if the first environment 120 is an ANDROID™ environment, the first environment applications 122 are configured to be executed by a Dalvik virtual machine. The first environment applications 122 include stacks and other suitable application components, and at least a subset of the first environment applications 122 are separable from one another. An application included in the first environment applications 122 comprises instructions that are recognizable by the first middleware 125, which operates in conjunction with a processor 152 to execute the instructions to provide one or more functions.

In the embodiment shown by FIG. 1, the first middleware 125 includes a first application framework 127 and a first runtime environment 129. However, in other embodiments, the first middleware 125 may include different and/or additional components, such as a radio interface module, a global positioning system (GPS) module or any other suitable component. The first environment applications 122 are managed by the first application framework 127 and interpreted by the first runtime environment 129. For example, the first runtime environment 129 includes an interpreter that translates an application from the first environment applications 122 during run-time of the application.

In an embodiment where the first environment 120 is an ANDROID™ environment, the first runtime environment 129 is a Dalvik register-based virtual machine (VM) that communicates with Dalvik libraries and/or tools in addition to additional components, such as the host kernel 140. The Dalvik libraries and/or tools are implemented on top of the host kernel 140 and implement functionality sufficient to execute the Dalvik register-based VM. In one embodiment, the Dalvik libraries are a subset of libraries supported by a GNU/Linux-based operating system and provide functionality optimized for implementation in mobile computing devices. This allows development of applications for execution by devices subject to more resource constraints than a desktop or laptop computer. A register-based virtual machine, such as the Dalvik register-based VM, is easier to optimize on a particular device hardware configuration than a virtual machine using a stack-based architecture (e.g., a virtual machine based on JAVA®). Further, an environment using a Dalvik, or similar, implementation replicates a complete middleware layer rather than merely replicating a byte-code interpreter, such as a virtual machine. Additionally, a Dalvik-based, or similar, implementation allows developers to design first environment applications 122 using a familiar syntax, such as a JAVA® syntax. Thus, in an embodiment where the first environment 120 includes first environment applications 122 prepared in Dalvik, or a similar configuration, the first environment applications 122 are byte-code interpreted applications.

In one embodiment, the second environment 130 includes second environment applications 132 and second middleware 135, which communicates with the second environment applications 132. In the embodiment shown by FIG. 1, the second middleware 135 includes a second application framework 137 and a second environment libraries and/or tools module 139. The second environment libraries and/or tools module 139 includes libraries for displaying data using a graphical user interface (GUI) and/or additional libraries or tools. However, in other embodiments, the second middleware 135 may include different and/or additional components, such as a desktop environment, a multimedia framework component, a window manager component or any other suitable component.

In one embodiment, the second environment applications 132 include one or more native applications that are comprised of instructions corresponding to the instruction set architecture of the host kernel 140 or the device hardware 150. One or more of the second environment applications 132 include a stack and/or additional components separate from other second environment applications 132. The second environment applications 132 are managed by the second application framework 137 and may use data and/or instructions from the second environment libraries and/or tools module 139 and/or other components included in the second middleware 135. An application included in the second environment applications 132 comprises instructions that are recognizable by the second middleware 135, which operates in conjunction with a processor 152 to execute the instructions to provide one or more functions. For example, if the second environment 130 is a GNU/Linux environment, the second environment applications 132 may be native applications using the instruction set of the host kernel 140, which may be implemented using GNU/Linux.

The first middleware 125 and the second middleware 135 are logically positioned between the first environment applications 122 and the second environment applications 132, respectively. The first middleware 125 and the second middleware 135 orchestrate interaction between the device hardware 150 and the first environment applications 122 and the second environment applications 132, respectively.

In the example shown by FIG. 1, the second environment 130 includes a plurality of logical memory partitions while the first environment comprises a single memory partition as well as system components. Further, in one embodiment, the second environment 130 and the host kernel 140 share a common instruction set. For example, the second environment 130 is a UBUNTU® stack, or a similar LINUX® stack. In an embodiment where the second environment 130 comprises a UBUNTU® stack, the host kernel 140 may also be implemented using UBUNTU®. However, in additional embodiments, the second environment 130 may alternatively comprise a different type of LINUX® environment, a SYMBAIN® environment, a WINDOWS® environment or another other suitable operating environment. For example, the second environment 130 may be a WINDOWS® environment and the host kernel 140 is also implemented using WINDOWS®. However, in other embodiments, the second environment 130 may comprise a single memory partition. Additionally, one or more additional environments may be included and may support one or multiple memory partitions. In additional embodiments, greater than two environments having a variety of different configurations independently coexist using the same host kernel 140.

In the embodiment shown by FIG. 1, the device hardware 150 comprises a processor 152 and a display device 154; however, in other embodiments the device hardware 150 includes different and/or additional components. In one embodiment, the device hardware 150 includes a computer-readable storage medium coupled to the processor 152. The computer-readable storage medium includes instructions that, when executed by the processor 152, execute one or more functions. Additionally, the device hardware 150 may include a communication device, such as a transceiver for wireless communication and/or a port for wired communication. In other embodiments, the device hardware 150 includes an audio output device, one or more input devices and/or any other suitable components.

The processor 152 processes data or instructions and may comprise various computing architectures. For example, the processor 152 may process data or instructions using a complex instruction set computer (CISC) architecture a reduced instruction set computer (RISC) architecture, an architecture implementing a combination of instruction sets or any other suitable instruction set. Although FIG. 1 shows a single processor 152, in other embodiments, the mobile computing system 100 may include multiple processors. The processor 152 transmits, processes and/or retrieves data from the first environment 120 and/or from the second environment 130 and/or from additional components.

The display device 154 is a device displaying electronic images and/or data. For example, the display device 154 comprises an organic light emitting diode display (OLED), a liquid crystal display (LCD) or any other device such as a monitor. In one embodiment, the display device 154 includes a touch-sensitive transparent panel for receiving data or allowing other interaction with the images and/or data displayed by the display device 154.

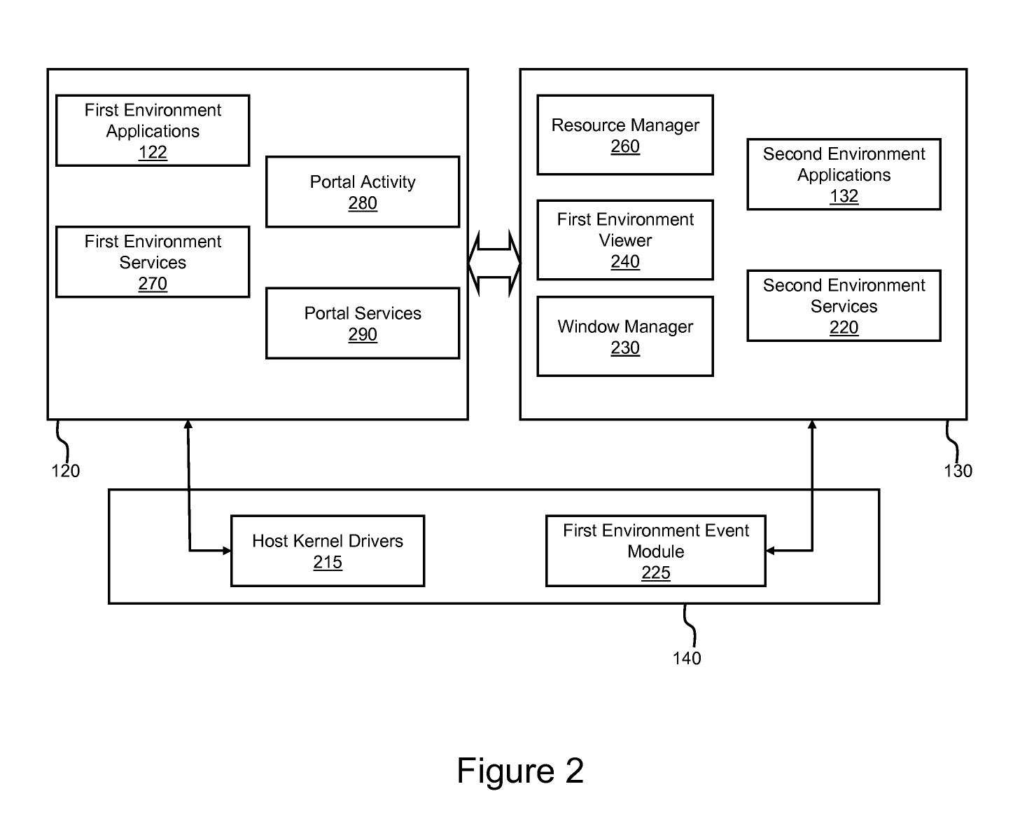

FIG. 2 is a block diagram of additional components of a mobile computing system 100 including multiple environments in accordance with some embodiments. In the embodiment shown by FIG. 2, the first environment 120 and the second environment 130 communicate with a host kernel 140. FIG. 2 illustrates the host kernel 140 including host kernel drivers 215 and a first environment event module 225. The host kernel drivers 215 include device drivers for one or more components of the device hardware 150. However, in other embodiments, the host kernel 140 includes different and/or additional modules.

FIG. 2 shows components of the first environment 120 and of the second environment 130 in addition to the components depicted by FIG. 1. In the embodiment illustrated by FIG. 2, the first environment 120 includes a first environment services module 270, a portal activity module 280 and a portal services module 290 in addition to the first environment applications 122. In an alternative embodiment, the portal activity module 280 is included in the first environment applications 122. Further, in one embodiment, the first environment services module 270 and the portal services module 290 are included in the first middleware 125, which is further described above in conjunction with FIG. 1.

Also, FIG. 2 shows components included in the second environment 130 in addition to those components further described above in conjunction with FIG. 1. In the embodiment shown by FIG. 2, the second environment 130 includes a window manager 230, a first environment viewer 240, a resource manager 260 and a second environment services module 220 in addition to the second environment applications 132. In one embodiment, one or more of the second environment services module 220, the window manager 230, the first environment viewer 240 and the resource manager 260 are included in the second middleware 135, further described above in conjunction with FIG. 1. In another embodiment, the first environment viewer 240 is included in the second environment applications 132.

The first environment viewer 240 displays a window including data and/or an application from the first environment on an interface displayed on a display device 154 when the second environment 130 is the primary environment. For example, the first environment viewer 240 displays a window showing one or more applications executed by the first environment 120 in a graphical user interface displayed when the second environment 130 is the primary environment. This allows a user to view and interact with the first environment 120 via the displayed window while the second environment 130 is the primary environment.

The first environment event module 225 communicates with the first environment viewer 240 and receives coordinate events, keyboard events or other events received by the first environment viewer 240. The received invents are communicated by the first environment event module 225 to an event hub. For example, the first environment event module 225 receives absolute coordinate and/or keyboard events from the first environment viewer 240. In one embodiment, the event hub communicates the received events to the first environment 120 or to one or more first environment applications 122.

The window manager 230 comprises instructions that, when executed by the processor 152, display data from the first environment 120 and/or the second environment 130 using the display device 154. The window manager 230 generates one or more windows in which data and/or an application is displayed. Additionally, the window manager 230 receives input from a user to modify the size, shape or location of a window displayed using the display device 154. For example, the window manager 230 receives input from a user to resize a window, such as an input repositioning a border of the window to increase or decrease the size of the displayed window.

The portal services module 290 comprises one or more instructions that, when executed by a processor 152, enable one or more services for the first environment 120 and/or manage communication with the resource manager 260 included in the second environment 130. In an embodiment where the first environment 120 is executed by a mobile computing device, the portal services module 290 is executed while the mobile computing device is operating. The portal services module 290 is also coupled to the portal activity module 280 and also receives broadcast events associated with the first environment 120.

The portal activity module 280 comprises computer readable instructions that, when executed by the processor 152, represent one or more applications included in the second environment 130. For example, if the second environment 130 is a UBUNTU® environment, the portal activity module 280 represents a specific UBUNTU® application. When the portal activity module 280 is accessed, the application included in the second environment 130 is displayed on a display device 154, allowing the application included in the second environment 130 to be viewed and/or accessed from the first environment 120.

Generally, multiple applications in an environment 120, 130 are capable of executing simultaneously in what is commonly referred to as a “stack” of executing applications. As discussed herein, the topmost application in a stack is deemed to have “focus.” Where multiple applications are available for access by a user, the application currently receiving input commands or data from a user is considered to be the application having “focus.” For example, if multiple windows corresponding to different applications are displayed on a display device 154, the application associated with the window currently receiving input from the user is the application having “focus.” In an embodiment, the second environment 130 enables display of multiple applications at a given time while the first environment 120 enables display of a single application at a time. For example, the second environment 130 allows multiple windows associated with different applications to be displayed at one time while the first environment 120 allows display of a single window associated with an application at one time. However, in alternative embodiments, the first environment 120 and the second environment 130 display different numbers of applications at a given time.

As further described above in conjunction with FIG. 1, the first environment 120 and the second environment 130 communicate with each other and also communicate with a single host kernel 140. In one embodiment, as described above in conjunction with FIG. 1, the first environment 120 includes a Dalvik register-based virtual machine replicating a complete middleware layer rather than merely replicating a byte-code interpreter, creating a possibility of conflict in the operation of the first middleware 125 and the second middleware 135 allocating resources through the host kernel 140 without appropriate steps. To avoid potential conflicts in resource allocation by the host kernel 140, the resource manager 260, included in the second environment 130, communicates directly with the portal services module 290 included in the first environment 120 and vice versa.

The resource manager 260 included in the second environment 130 comprises instructions that, when executed by the processor 152, manage resources shared by the first environment 120 and the second environment 130. For example, the resource manager 260 manages use of resources such as the display device 154, one or more input devices, a power supply, additional output devices and other suitable resources by the first environment 120 and the second environment 130. Further, the resource manager 260 maintains state information associated with the mobile computing system 100. The resource manager 260 also controls access to the device hardware 150 by the first environment 120 and the second environment 130. For example, the resource manager 260 identifies and/or modifies whether a user interface associated with the first environment 120 or with the second environment 130 is displayed using the display device 154.

In one embodiment, the portal services module 290 receives data for communication from the first environment 120 to the resource manager 260 included in the second environment 130. Further, the portal services module 290 receives data from the resource manager 260 that is communicated to the first environment 120 from the second environment 130. In one embodiment, the resource manager 260 also includes a status-discoverable application programming interface (API) to the portal services module 290. The status-discoverable API may be called by the resource manager 260 at anytime. Additionally, the resource manager 260 obtains and processes run-time status to maintain a state machine. In one embodiment, for the first environment 120, the portal services module 290 provides run-time status to processes. Similarly, the portal services module 290 requests and receives status updates from processes that provide status information. In one embodiment, the portal services module 290 is included in the first runtime environment 129.

The resource manager 260 provides run-time status to processes in the second environment 130 requesting and/or requiring run-time status. In one embodiment, the host kernel drivers 215 communicate with the resource manager 260 as well as processes providing run-time status information. For example, the status-discoverable API of the resource manager 260 arbitrates access to user interface devices, such as the display device 154, a touch screen, a graphical user interface or a similar user interface device. As another example, the status-discoverable API arbitrates access to power supplies, such as a battery or another power source.

As discussed above, in conjunction with FIG. 1, the first environment 120 and the second environment 130 are independent form each other and co-exist with respect to each other. Each of the first environment 120 and the second environment 130 is a fully functioning environment that does not rely upon the other environment to function. Unlike conventional configurations, the first environment 120 and the second environment 130 do not co-exist in a virtualization or emulation scheme. Rather, the first environment 120 and the second environment 130 both operate on a single, shared host kernel 140. The first environment 120 and the second environment 130 have run-time coexistence in which both the first environment and the second environment 130 are run as stand-alone, native environments. Neither the first environment 120 nor the second environment 130 is recompiled as a common run-time environment, such as a C run-time environment, is not leveraged for both environments. Because of the first environment 120 and the second environment 130, a user is capable of accessing an application that is configured for operation on one of the environments without interrupting an interaction with another environment.

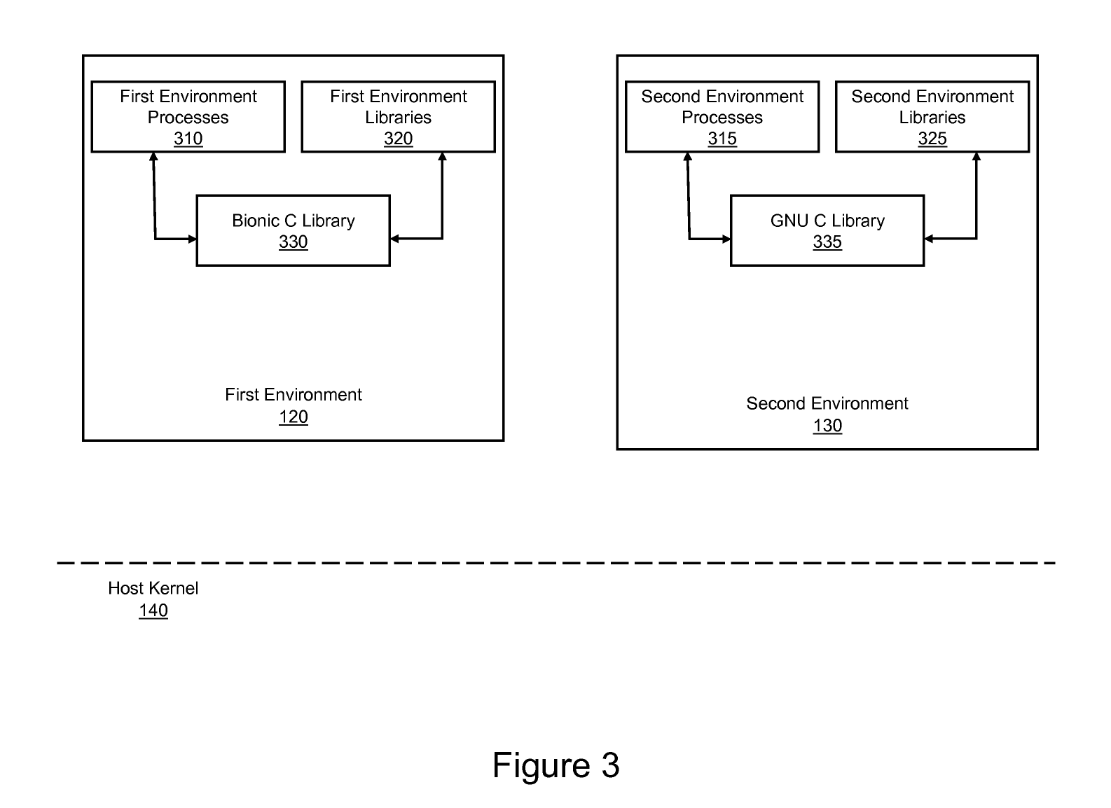

FIG. 3 is a block diagram of an example run-time coexistence schema in accordance with some embodiments. In the example shown by FIG. 3, the first environment 120 is an ANDROID™ environment and the second environment 130 is a UBUNTU® environment. Generally, the first environment 120 and the second environment 130 operate in a separate run-time environment providing services for applications and/or processes while the mobile computing system 100 is operating.

In the embodiment shown by FIG. 3, first environment processes 310 and first environment libraries 320 access a Bionic C library 330, which is optimized and modified for the first environment 120. In one embodiment, the first environment libraries 320 and the Bionic C library 330 are included in the first runtime environment 129. Also in the embodiment shown by FIG. 3, second environment processes 315 and second environment libraries 325 communicate with a GNU C library 335. In one embodiment, the second environment libraries 325 and the GNU C library 335 are included in the second environment libraries and/or tools module 139. Thus, the first environment 120 and the second environment 130 each operate using its respective C library without conflicting with the library used by the other environment 130, 120.

### Methods

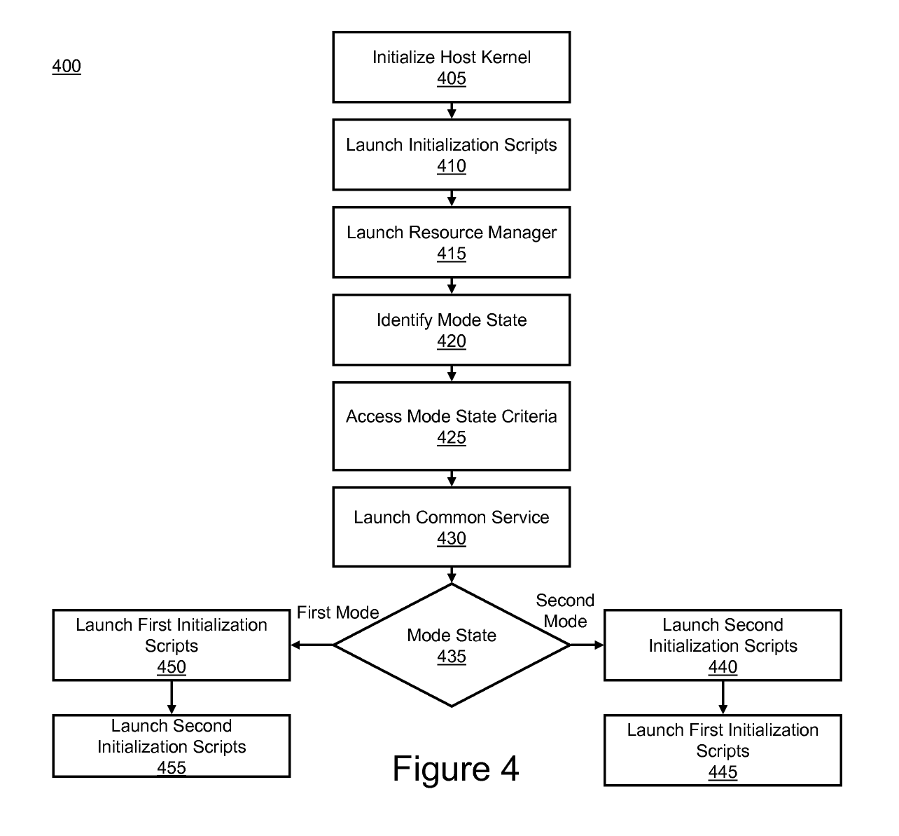

FIG. 4 is a flow chart of a method 400 for booting a mobile computing system 100 including multiple environments in accordance with some embodiments. In one embodiment, the steps of the method 400 are implemented by instructions for performing the described actions embodied or stored within a computer-readable storage medium, such as a flash memory or a random access memory, that are executable by a processor, such as the processor 152. Additionally, the method 400 may be implemented in embodiments of hardware, software or combinations of hardware and software. Moreover, in some embodiments, the method 400 includes different and/or additional steps than those shown by FIG. 4.

The method 400 includes environment-specific steps and steps performed by different environments. However, the boot sequence may be modified based on rules associated with a predetermined device state of the mobile computing system 100 dictating the booting sequence. For example, if the mobile computing system 100 is coupled to a peripheral device, such as a monitor, the mobile computing system 100 operates in a second mode where the second environment 130 is the default primary environment. Alternatively, if the mobile computing system 100 is not coupled to a peripheral device, the mobile computing system 100 operates in a first mode where the first environment 120 is the default primary environment.

While one of the first environment 120 or the second environment 130 acts as a primary environment, both environments are launched simultaneously or nearly simultaneously. Additionally, once the first environment 120 and the second environment 130 are launched and one of the environments serves as the primary environment, the secondary environment operates in the background relative to the primary environment, in case the state changes and the secondary environment becomes the primary environment. For example, when the mobile computing system 100 is in the second mode and the peripheral is unplugged, there is an automatic transition to the first mode, resulting in the secondary environment becoming the primary environment and vice versa.

In the embodiment shown by FIG. 4, the host kernel 140 is initialized 405. For example, a bootloader program is launched or initialized. After initialization, the host kernel 140 launches 410 initialization scripts and launches 415 the resource manager 260. After launching 415 the resource manager, the mode state is identified 420, and a reference library is accessed 425 to determine criteria associated with the identified mode or criteria dictated by the identified mode.

Services common to the first environment 120 and the second environment 130 are then launched 430 and the identified mode state is determined 435. Responsive to determining 435 that a first mode is identified, initialization scripts associated with the first environment 120 are launched 450 and then initialization scripts associated with the second environment 130 are launched 455. Hence, in the first mode, the first environment 120 operates as the primary environment while the second environment operates as the secondary environment.

Responsive to determining 435 that a second mode is identified, initialization scripts associated with the second environment 130 are launched 440 then initialization scripts associated with the first environment 120 are launched 445. Thus, in the second mode, the second environment 130 operates as the primary environment, while the first environment 120 operates as the secondary environment.

However, regardless of which environment is the primary environment, both the first environment 120 and the second environment 130 are launched and become operational before the mobile computing system 100 is operational. Further, because services common to the first environment 120 and the second environment 130 are launched 430 prior to the environment-specific initialization scripts, the primary and secondary environments are essentially launched in parallel. However, primary environment-specific services are launched before services specific to the secondary environment. By separating launching 430 of common services from environment-specific initialization scripts, the mobile computing system 100 is able to quickly become operational with multiple co-existing and independent environments. While both the primary environment and secondary environment are executing when the mobile computing system 100 is operational, the secondary environment operates in the background relative to the primary environment. Either the first environment 120 or the second environment 130 may be the primary environment; additionally, the primary environment may be switched to the secondary environment automatically or responsive to user commands.

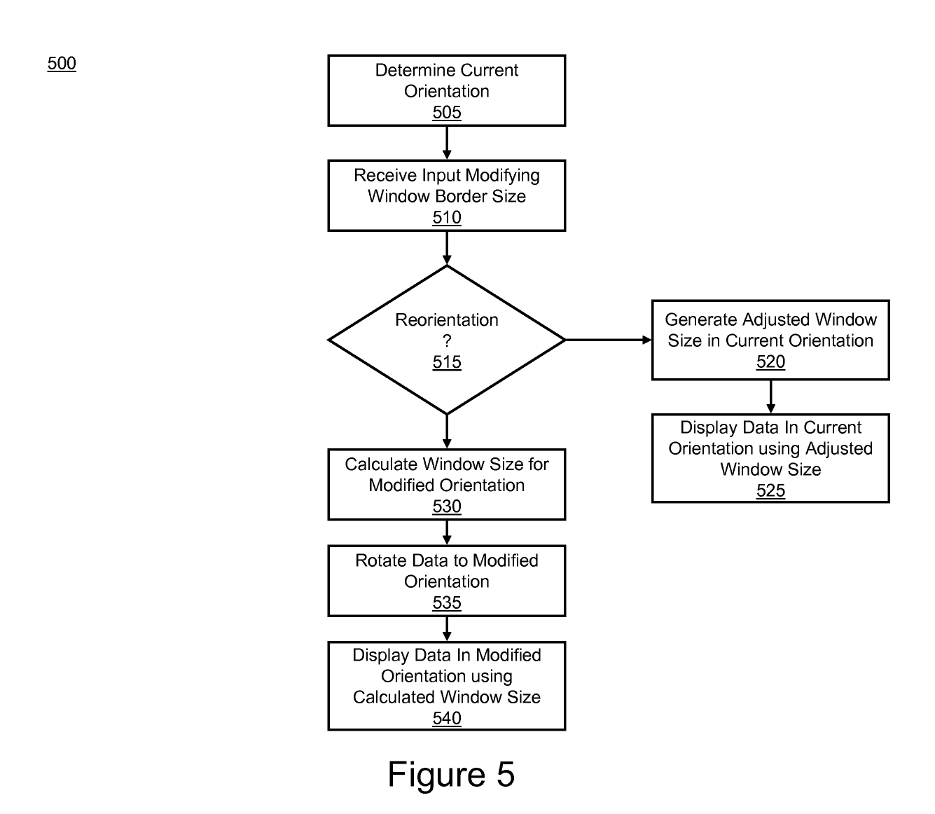

FIG. 5 is a flow chart of a method 500 for reorienting data responsive to resizing a window including data in accordance with some embodiments. In one embodiment, the steps of the method 500 are implemented by instructions for performing the described actions embodied or stored within a computer-readable storage medium, such as a flash memory or a random access memory, that are executable by a processor, such as the processor 152. Additionally, the method 500 may be implemented in embodiments of hardware, software or combinations of hardware and software. Moreover, in some embodiments, the method 500 includes different and/or additional steps than those shown by FIG. 5.

In the embodiment shown by FIG. 5, the window manager 230 or the first environment viewer 240 of the second environment 130 generates a window used by the first environment viewer 240 to display data from the first environment on a display device 154. For example, the first environment viewer 240 presents data from an embedded operating system using a window generated by the window manager 230. This beneficially allows a user to view and access applications or data from the first environment 120 from the second environment 130. Initially, the orientation of the content presented by the window manager is determined 505. In one embodiment, the first environment 120 has two types of orientations, allowing different presentation of data based on the orientation of the mobile computing system 100. For example, the first environment 120 may display data in a first orientation or in a different second orientation to facilitate interaction with the displayed data. In one embodiment the first orientation and the second orientation are orthogonal to each other. For example, the first orientation displays data in a portrait orientation while the second orientation displays data in a landscape orientation.

After determining 505 current orientation and displaying data, an input is received 510 that modifies the size of the window in which the data is displayed. For example, an input modifying a border of the window displaying data from the first environment 120 is received 510. In one embodiment, a user accesses a border of the window and drags the border to a new location to modify the window size. Responsive to receiving 510 the input modifying the window size, the second environment 130 determines 515 whether to re-orient the data displayed by the window.

For example, the window manager 230 or the first environment viewer 240 determines 515 whether the modified window size exceeds a threshold size to determine 515 whether to reorient the data displayed by the window. Alternatively, the window manager 230 or the first environment viewer 240 determines 515 whether the modified window size results in an aspect ratio associated with the displayed data differing from a predetermined aspect ratio.

Responsive to determining 515 that the data displayed by the window does not need to be re-oriented, the window manager 230 or the first environment viewer 240 generates 520 an adjusted window having the modified size specified by the received input. Data is displayed 525 in the adjusted window using the current orientation. For example, if the modified window size is below a threshold value, the window is resized and data is still displayed 525 in the current orientation.

Responsive to determining 515 that the data displayed by the window should be re-oriented, the window manager 230 or the first environment viewer 240 calculates 530 a window size for the modified orientation. After calculating 530 the window size for the modified orientation, the window manager 230 or the first environment viewer 240 rotates 535 the data to a modified orientation. For example, the data is rotated 535 from a first orientation to a second orientation. In one embodiment, the first orientation is orthogonal to the second orientation, so the data is rotated 535 ninety degrees from the current orientation to the modified orientation. The data is then displayed 540 by the window manager 230 and/or the first environment viewer 240 using the modified orientation and the window size calculated for the modified orientation.

Thus, responsive to receiving 510 an input to modify the size of a window displaying data from the first environment 120, the window manager 230 or the first environment viewer 240 determines 515 whether to change the orientation in which the data is displayed. Responsive to determining 515 that the resized window has a size exceeding a threshold size or results in an aspect ratio for the displayed data differing from a predetermined aspect ratio, the window manager 230 or the first environment viewer 240 modifies the orientation used to display the data from the first environment and resizes the window. For example, the window manager 230 or the first environment viewer 240 rotates data from a portrait orientation to a landscape orientation responsive to receiving input that resizes a window beyond a specified threshold. As another example, the window manager 230 or the first environment viewer 240 rotates data from a landscape orientation to a portrait orientation responsive to receiving input resizing a window beyond a specified threshold.

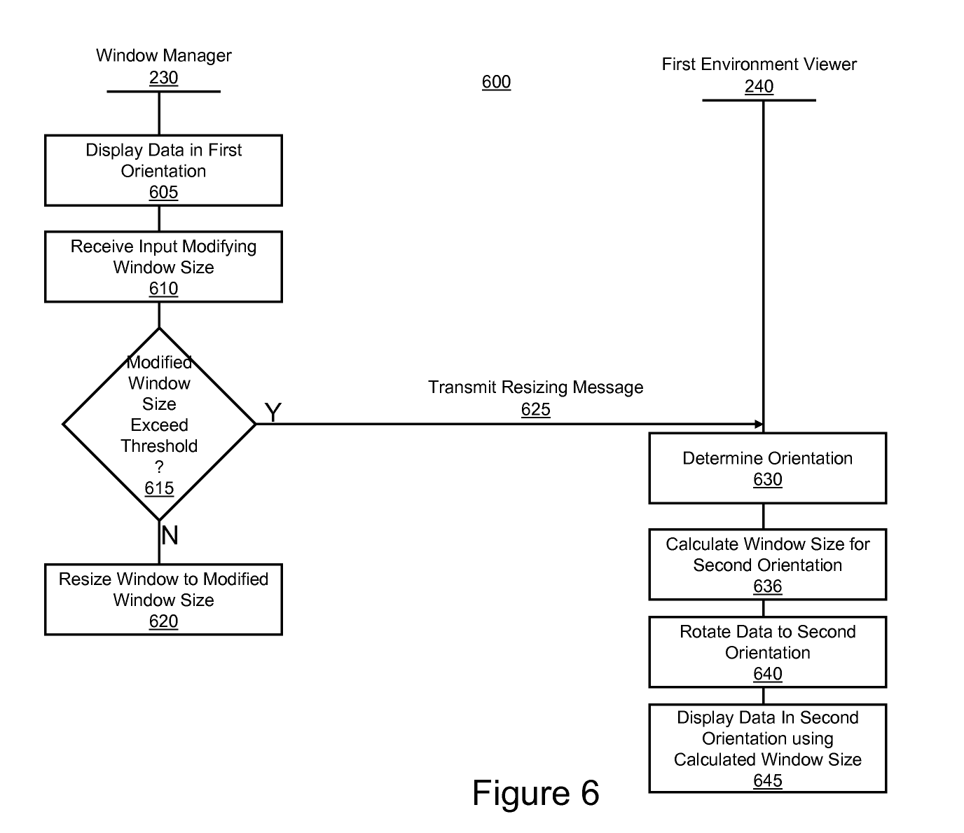

FIGS. 6-8 illustrate different embodiments of methods for reorienting data responsive to resizing a window including the data.

FIG. 6 is an event diagram of a method 600 for reorienting data responsive to resizing a window including data in accordance with some embodiments. The method 600 shown by FIG. 6 illustrates communication between a window manager 230 and a first environment viewer 240 included in the second environment 130.

In the embodiment depicted by FIG. 6, the window manager 230 displays 605 a window including data having a first orientation. For example, the window manager 230 displays 605 a window data in a portrait orientation. The window manager 230 then receives 610 an input modifying a size of the window in which the data is displayed. For example, a user accesses a border of the window and repositions the border to a second location to modify the size of the window.

After receiving 610 the input modifying the window size, the window manager 230 determines 615 whether the modified window size exceeds a threshold. For example, the window manager 230 determines 615 whether the modified window size exceeds a threshold size in a first direction. As another example, the window manager 230 determines 615 whether the modified window size results in an aspect ratio differing from a predetermined aspect ratio.

Responsive to determining 615 that the modified window size does not exceed the threshold, the window manager 230 resizes 620 the window to the modified window size and continues displaying data in the resized window in the first orientation. Responsive to determining 615 that the modified window size exceeds the threshold, the window manager 230 transmits 625 a resizing message to the first environment viewer 240. In one embodiment, the resizing message identifies the window size and the orientation of the data displayed by the window.

After receiving the resizing message, the first environment viewer 240 determines 630 the orientation of the data displayed by the window manager 230. In the example of FIG. 6, the first environment viewer 240 determines 630 that the window manager 230 displays 605 data in the first orientation. The first environment viewer 240 then calculates 635 a window size associated with a second orientation and rotates 640 the data displayed by the window to the second orientation. The first environment viewer 240 then displays 645 the data in the second orientation using a window having the window size associated with the second orientation.

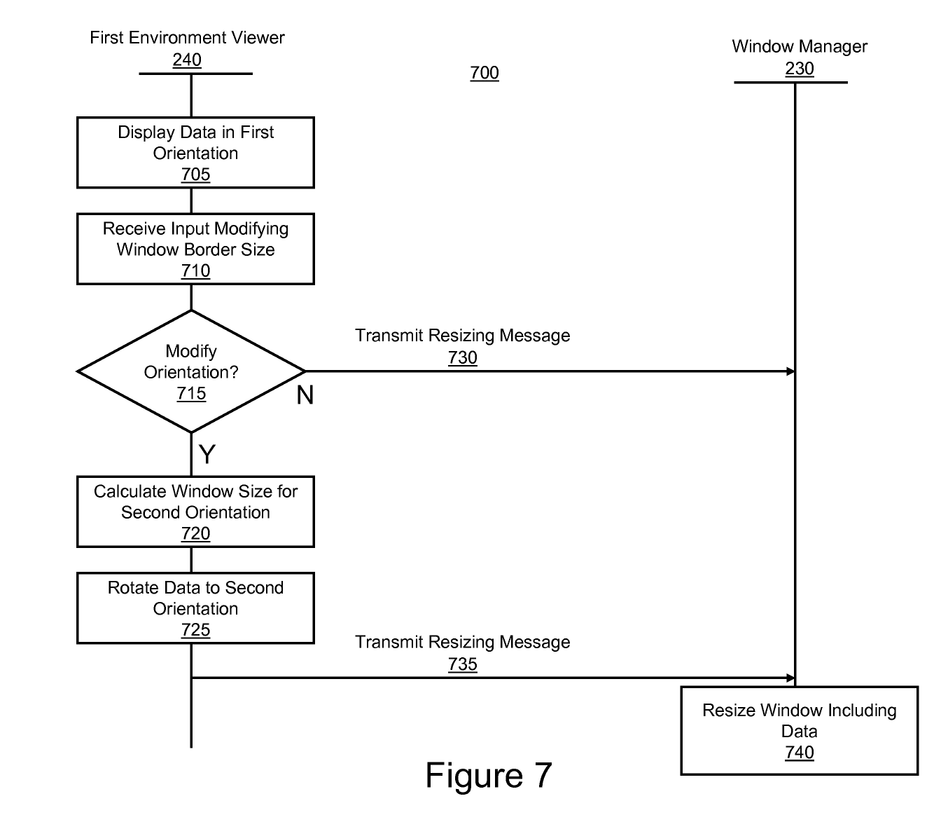

FIG. 7 is an event diagram of an alternative method 700 for reorienting data responsive to resizing a window including data in accordance with some embodiments. The method 700 shown by FIG. 7 illustrates communication between a window manager 230 and a first environment viewer 240 included in the second environment 130.

In the embodiment depicted by FIG. 7, the first environment viewer 240 displays 705 data in a window using a first orientation. For example, the first environment viewer 240 displays 705 data in a portrait orientation. The first environment viewer 240 then receives 710 an input modifying a size of the window displaying the data. For example, a user modifies the window size by accessing a border of the window and repositioning the border.

After receiving 710 the input modifying the window size, the first environment viewer 240 determines 715 whether to modify the orientation with which the data is displayed. For example, the first environment viewer 240 determines 715 whether the modified window size exceeds a threshold, such as a threshold size in a first direction or in a second direction. As another example, the first environment viewer 240 determines 715 whether the modified window size results in a change of the aspect ratio of the data displayed using the modified window size. For example, the first environment viewer 240 determines 715 whether the aspect ratio of data displayed using the modified window size differs from a predetermined aspect ratio.

Responsive to determining 715 not to modify the orientation used to display data, the first environment viewer 240 transmits 730 a resizing message to the window manager 230. In one embodiment, the resizing message identifies the window size and the orientation of data displayed by the window. After receiving the resizing message, the window manager 230 resizes 740 the window including the data based on the resizing message. The window manager 230 resizes 740 the window to the window size included in the resizing message and displays the data using the orientation identified by the resizing message.

Responsive to determining 715 to modify the orientation used to display data, the first environment viewer 240 calculates 720 a window size for displaying data using a second orientation. For example, the first environment viewer 240 calculates 720 a window size for displaying data in the second orientation having a predetermined aspect ratio. The first environment viewer 240 rotates 725 the data to the second orientation and transmits 735 a resizing message to the window manager 230. In one embodiment, the resizing message identifies the window size and the orientation of data displayed by the window. The window manager 230 then resizes 740 the window to the window size included in the resizing message and displays the data using the orientation identified by the resizing message.

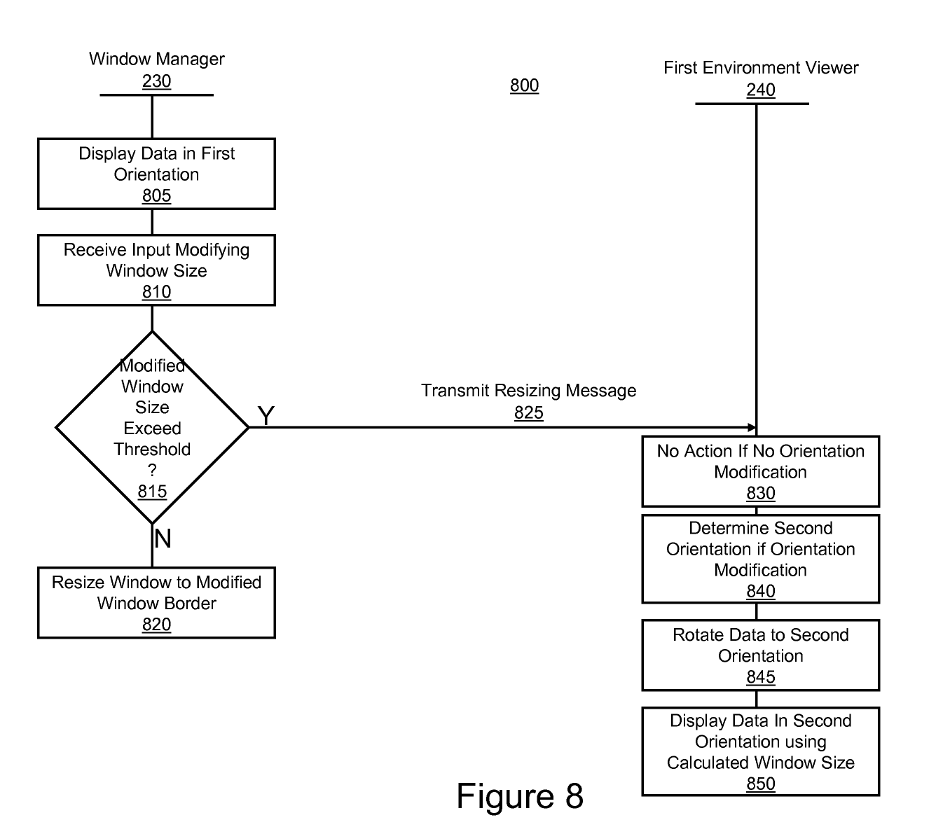

FIG. 8 is an event diagram of another method 800 for reorienting data responsive to resizing a window including data in accordance with some embodiments. The method 800 shown by FIG. 8 illustrates communication between a window manager 230 and a first environment viewer 240 included in the second environment 130.

In the embodiment depicted by FIG. 8, the window manager 230 displays 805 data having a first orientation in a window. For example, the window manager 230 displays data in a portrait orientation. The window manager 230 then receives 810 an input modifying a size of the window in which the data is displayed. For example, a user modifies the size of the window by accessing a border of the window and repositioning the border to a second location.

After receiving 810 the input modifying the window size, the window manager 230 determines 815 whether the modified window size exceeds a threshold. For example, the window manager 230 determines 815 whether the modified window size exceeds a threshold size in one or more directions. As another example, the window manager 230 determines 815 whether the modified window size results in displaying data using a aspect ratio differing from a predetermined aspect ratio.

Responsive to determining 815 that the modified window size does not exceed the threshold, the window manager 230 resizes 820 the window to the modified window size and continues to display data in the window in the first orientation. Responsive to determining 815 that the modified window size exceeds the threshold, the window manager 230 transmits 825 a resizing message to the first environment viewer 240. In one embodiment, the resizing message identifies the window size and the orientation of data displayed by the window.

After receiving the resizing message, the first environment viewer 240 determines from the resizing message whether to modify the orientation of the data. If the orientation of the data is not modified, the first environment viewer 240 performs 830 no action. However, if the resizing message indicates that the orientation of the data differs from the first orientation, the first environment viewer 240 determines 840 a second orientation from the resizing message. For example, if the window manager 230 initially displays 805 data in a portrait orientation and the resizing message identifies a landscape orientation for displaying the data, the first environment viewer 240 determines 840 the landscape orientation from the resizing message.

The first environment viewer 240 then rotates 845 the data displayed by the window to the second orientation identified from the resizing message. The first environment viewer then displays 850 the data in the second orientation in a window having a size identified by the resizing message or a size determined by the first environment viewer from the resizing message.

### Example Implementation

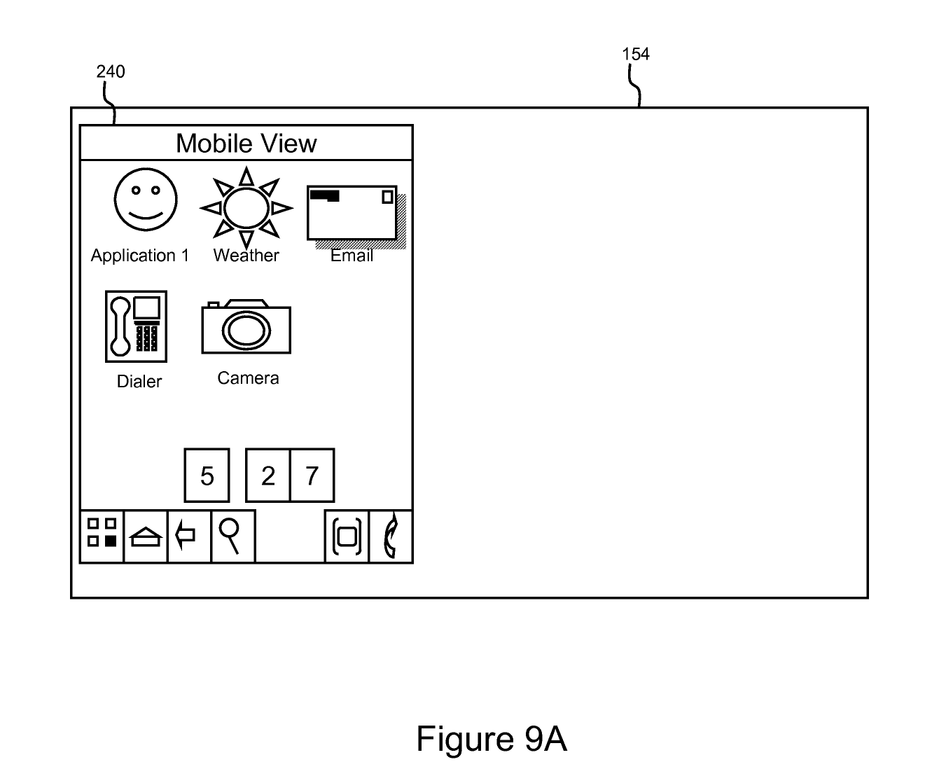

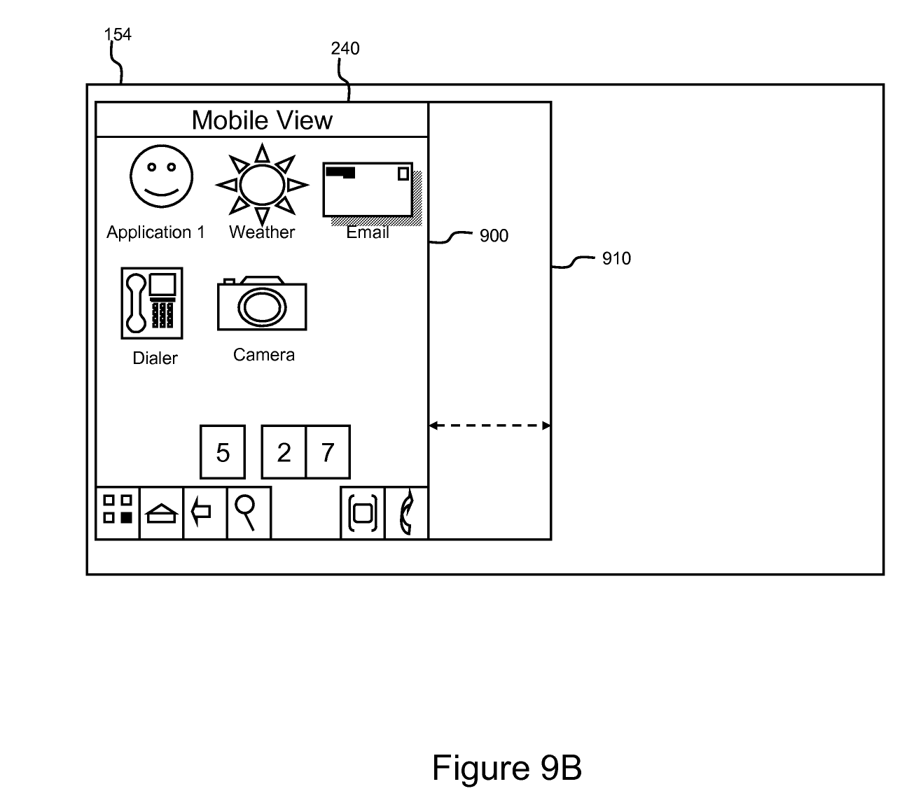

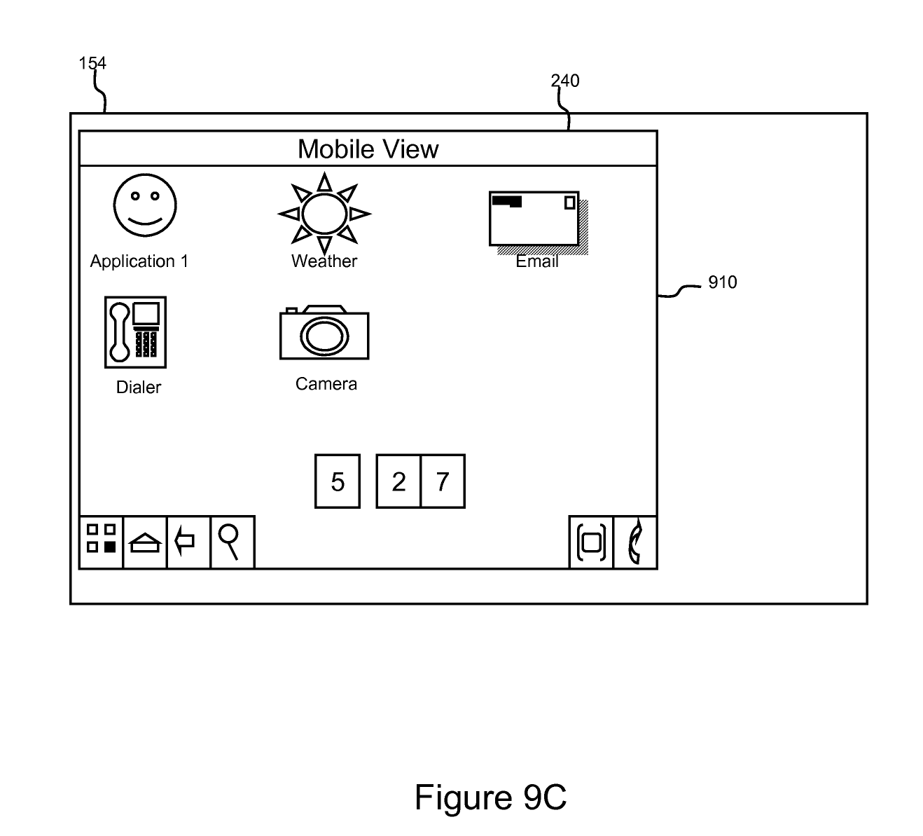

FIGS. 9A-9C illustrate an example of reorienting data responsive to resizing a window in accordance with some embodiments. In the example shown by FIGS. 9A-9C, the first environment viewer 240 displays data from the first environment 120 on a display device 154 when the second environment 130 is the primary environment. Thus, the first environment viewer 240 allows application or data associated with the first environment 120 to be viewed and/or modified while the second environment 130 is the primary environment. FIG. 9A shows the first environment viewer 240 displayed on a display device 154 in a window.

FIG. 9B shows modification of the size of the window displaying the first environment viewer 240. In the example shown by FIG. 9B, the window is resized to a modified location 910. For example, a user accesses a border of the window and repositions the border from a starting location 900 to the modified location 910. In the example shown by FIG. 9B, moving the border from the starting location 900 to the modified location 910 increases the size of the window; however, in other embodiments moving the border from a starting location 900 to a modified location 910 reduces the size of the window displaying the first environment viewer 240. In FIGS. 9A and 9B, the first environment viewer 240 displays data in a first orientation. For example, the first environment viewer 240 displays data in a portrait orientation in FIGS. 9A and 9B.

In the example of FIG. 9B, the modified location 910 of the window border exceeds a threshold location or modifies the aspect ratio used to display the data. Accordingly, the first environment viewer 240 and/or the window manager 230 included in the second environment rotate the data displayed by the first environment viewer from the first orientation to a second orientation. In the example of FIG. 9C, the first environment viewer 240 displays data in a landscape orientation while FIGS. 9A and 9B display data in a portrait orientation. Additionally, in FIG. 9C, the window displaying the first environment viewer 240 is resized so that its borders align with the modified location 910. In contrast, conventional techniques would merely resize the window to encompass the size bounded by the modified location 910 without modifying the orientation with which the data is displayed.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” and/or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
displaying, on a display device, data having a first orientation in a window, the window having a size;
receiving an input modifying the size of the window;
determining whether to reorient the data displayed in the window based on the modified size of the window;
responsive to determining to reorient the data displayed in the window, modifying the data to a second orientation;
resizing the window to the modified size; and
displaying, on the display device, the data in the second orientation in the window having the modified size.

2. The method of claim 1, wherein the first orientation is orthogonal to the second orientation.

3. The method of claim 2, wherein the first orientation is a portrait orientation and the second orientation is a landscape orientation.

4. The method of claim 2, wherein the first orientation is a landscape orientation and the second orientation is a portrait orientation.

5. The method of claim 1, wherein the input modifying the size of the window moves a border of the window from a first location to a second location.

6. The method of claim 5, wherein determining whether to reorient the data displayed in the window based on the modified size of the window comprises:
determining whether the second location exceeds a threshold location.

7. The method of claim 1, wherein determining whether to reorient the data displayed in the window based on the modified size of the window comprises:
determining whether an aspect ratio associated with displaying the data in the first orientation in the window having the modified size differs from a predetermined aspect ratio.

8. The method of claim 1, further comprising:
responsive to determining not to reorient the data displayed in the window, resizing the window to the modified size and displaying the data in the first orientation in the window having the modified size.

9. An apparatus comprising:
a processor;
a display device coupled to the processor; and
a computer-readable storage medium coupled to the processor and to the display device, the computer-readable storage medium including instructions that, when executed by the processor cause the processor to:
display, on the display device, data having a first orientation in a window, the window having a size;
receive an input modifying the size of the window;
determine whether to reorient the data displayed in the window based on the modified size of the window;
responsive to determining to reorient the data displayed in the window, modify the data to a second orientation;
resize the window to the modified size; and
display, on the display device, the data in the second orientation in the window having the modified size.

10. The apparatus of claim 9, wherein the first orientation is orthogonal to the second orientation.

11. The apparatus of claim 10, wherein the first orientation is a portrait orientation and the second orientation is a landscape orientation.

12. The apparatus of claim 10, wherein the first orientation is a landscape orientation and the second orientation is a portrait orientation.

13. The apparatus of claim 9, wherein the input modifying the size of the window moves a border of the window from a first location to a second location.

14. The apparatus of claim 13, wherein determine whether to reorient the data displayed in the window based on the modified size of the window comprises:
determine whether the second location exceeds a threshold location.

15. The apparatus of claim 9, wherein determine whether to reorient the data displayed in the window based on the modified size of the window comprises:
determine whether an aspect ratio associated with displaying the data in the first orientation in the window having the modified size differs from a predetermined aspect ratio.

16. The apparatus of claim 9, wherein the computer-readable storage medium further includes instructions that, when executed by the processor cause the processor to:
responsive to determining not to reorient the data displayed in the window, resize the window to the modified size and display the data in the first orientation in the window having the modified size.

17. A method comprising:
displaying, in a window rendered on a display device, data from a first environment while operating in a second environment, the data having a first orientation and the window having a size, wherein the first environment and the second environment both operates on a single host kernel shared between the first environment and the second environment;
receiving an input modifying the size of the window;
determining whether to reorient the data displayed in the window based on the modified size of the window;
responsive to determining to reorient the data displayed in the window, modifying the data to a second orientation;
resizing the window to the modified size; and
displaying, in the window rendered on the display device while operating in the second environment, the data from the first environment in the second orientation in the window having the modified size.

18. The method of claim 17, wherein the first orientation is orthogonal to the second orientation.

19. The method of claim 17, wherein the first orientation and the second orientation are associated with the first environment.
